(19) United States
(12) Patent Application Publication
(10) Pub. No.: US 2024/0213605 A1
(43) Pub. Date: Jun. 27, 2024

(54) BATTERY MODULE

(71) Applicant: HONDA MOTOR CO., LTD., Tokyo (JP)

(72) Inventors: Yosuke YOSHIZAWA, Saitama (JP); Hidemasa USUI, Saitama (JP); Takeo FUJII, Saitama (JP)

(21) Appl. No.: 18/396,643

(22) Filed: Dec. 26, 2023

(30) Foreign Application Priority Data
Dec. 27, 2022 (JP) 2022-210253

(51) Int. Cl. H01M 50/242; H01M 50/204; H01M 50/291; H01M 50/293

(52) U.S. Cl. CPC H01M 50/242; H01M 50/204; H01M 50/291; H01M 50/293

(57) ABSTRACT

Provided is a battery module including a battery cell stack in which a plurality of battery cells are stacked, a pair of plate-shaped members provided at both ends of the battery cell stack in a stacking direction, and a cushioning material disposed between the plurality of battery cells and/or between the battery cell stack and one of the plate-shaped members. The cushioning material includes a pair of first elastic members arranged on both outer sides in the stacking direction of the battery cell stack, and a second elastic member disposed between the pair of first elastic members. The second elastic member has a spring constant per unit area of 0.9 MPa/mm or more.

This application is based on and claims the benefit of priority from Japanese Patent Application No. 2022-210253, filed on 27 Dec. 2022, the content of which is incorporated herein by reference.

### BACKGROUND OF THE INVENTION

### Field of the Invention

The present invention relates to a battery module.

### Related Art

In recent years, research and development have been carried out on secondary batteries that contribute to energy efficiency in order to ensure that many people have access to affordable, reliable, sustainable, and advanced energy.

Since battery cells expand and contract as they are charged and discharged, the battery module includes, for example, a pair of end plates provided at both ends of the battery cell stack in the stacking direction, and a binding bar that restrains the battery cell stack between the pair of end plates.

However, all-solid-state battery cells undergo large volume changes due to expansion and contraction during charging and discharging, which changes the dimensions of the battery module, making it difficult to mount the battery module in a vehicle.

Patent Document 1 discloses an assembled battery in which gap adjustment units are intermittently arranged between all-solid-state battery cells. Here, the gap adjustment unit has an elastic body disposed between a pair of plates.

### CITATION LIST

### Patent Document

Patent Document 1: Japanese Unexamined Patent Application, Publication No. 2020-77500

### SUMMARY OF THE INVENTION

However, there is room for improvement in the energy density of the battery module.

An object of the present invention is to provide a battery module capable of increasing energy density.

(1) A first aspect is a battery module including a battery cell stack in which a plurality of battery cells are stacked, a pair of plate-shaped members provided at both ends of the battery cell stack in a stacking direction, and a cushioning material disposed between the plurality of battery cells and/or between the battery cell stack and one of the plate-shaped members. The cushioning material includes a pair of first elastic members arranged on both outer sides in the stacking direction of the battery cell stack, and a second elastic member disposed between the pair of first elastic members. The second elastic member has a spring constant per unit area of 0.9 MPa/mm or more.

(2) In a second aspect according to the first aspect, the second elastic member has a porous structure.

(3) In a third aspect according to the second aspect, the second elastic member includes rubber.

(4) In a fourth aspect according to the first aspect, the second elastic member has a leaf spring structure.

(5) In a fifth aspect according to the fourth aspect, the second elastic member is a wave-shaped leaf spring.

(6) In a sixth aspect according to the fourth or fifth aspect, the second elastic member includes a resin.

(7) In a seventh aspect according to any one of the first to sixth aspects, the battery cells are solid-state battery cells.

According to the present invention, it is possible to provide a battery module capable of increasing energy density.

### BRIEF DESCRIPTION OF THE DRAWINGS

FIG. 1 is a sectional view showing an example of a battery module of the present embodiment;

FIG. 2 is a partially exploded perspective view showing a cushioning material in FIG. 1;

FIG. 3 is a graph showing a relationship between a thickness of a second elastic member and a surface pressure due to expansion and contraction of battery cells;

FIG. 4 is a side view showing a modification of the cushioning material in FIG. 2; and

FIG. 5 is a side view showing a modification of the cushioning material in FIG. 2.

### DETAILED DESCRIPTION OF THE INVENTION

Hereinafter, embodiments of the present invention will be described with reference to the drawings.

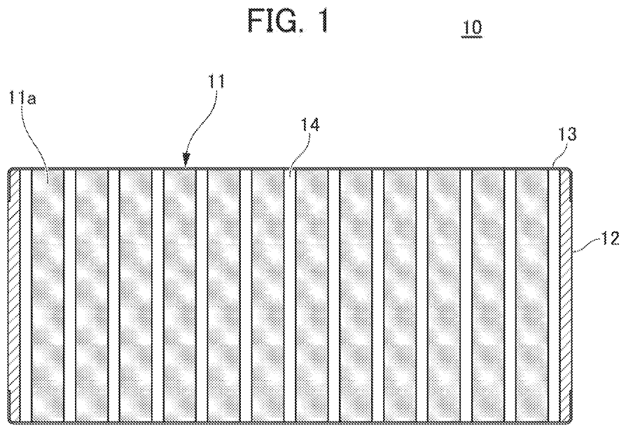

FIG. 1 shows an example of a battery module of the present embodiment.

A battery module 10 includes a battery cell stack 11 in which a plurality of battery cells 11a are stacked, end plates 12 as a pair of plate-shaped members provided at both ends of the battery cell stack 11 in the stacking direction, and binding bars 13 as restraining members for restraining the battery cell stack 11 between the pair of end plates 12. Here, the binding bars 13 are provided at two locations, that is, an upper portion and a lower portion in the drawing.

In the battery module 10, cushioning materials 14 are arranged between the plurality of battery cells 11a and between the battery cell stack 11 and each of the end plates 12.

The cushioning materials 14 may be arranged between the plurality of battery cells 11a or between the battery cell stack 11 and each of the end plates 12.

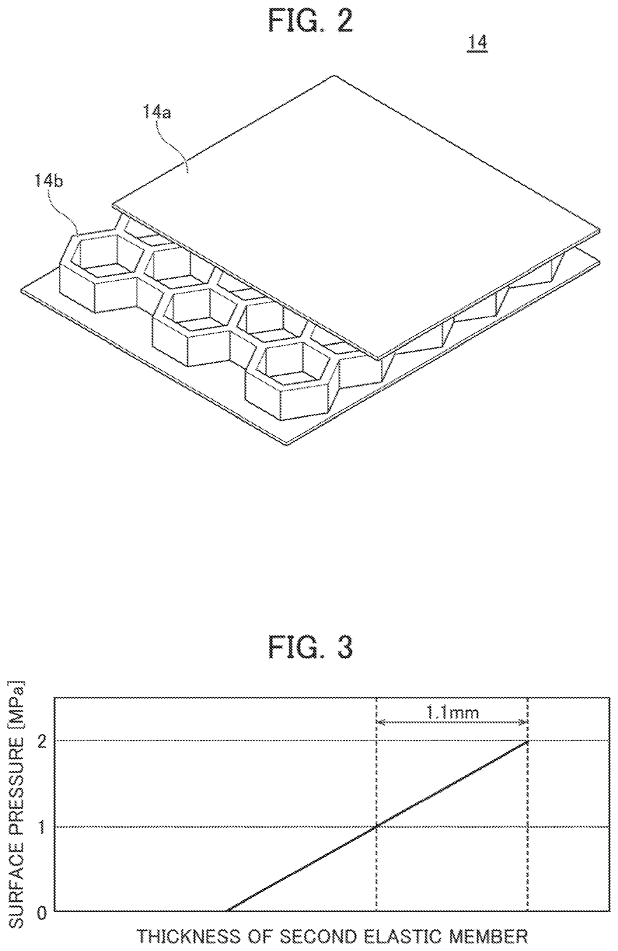

As shown in FIG. 2, the cushioning material 14 includes foam bodies 14a as a pair of first elastic members arranged on both outer sides in the stacking direction of the battery cell stack 11, and a honeycomb structure 14b as a second elastic member disposed between the pair of foam bodies 14a. The spring constant per unit area of the second elastic member is 0.9 MPa/mm or more.

Here, all-solid-state battery cells as the battery cells 11a each have a maximum change in thickness due to expansion and contraction during charging and discharging of about 1.1 mm, and each is restrained by a surface pressure of 1 MPa (SOC 0%) to 2 MPa (SOC 100%). Therefore, in order to increase the energy density of the battery module 10 by absorbing changes in thickness due to expansion and contraction of the battery cells 11a by the second elastic members, the minimum value of the spring constant per unit area of the second elastic member is set to the following:

(2 [MPa]−1 [MPa])/1.1 [mm]≈0.9 [MPa/mm]

### (see FIG. 3).

The spring constant per unit area of the second elastic member is not limited, but is, for example, 2.0 MPa/mm or less.

The Poisson's ratio of the first elastic member is preferably 0.3 or less. When the Poisson's ratio of the first elastic member is 0.3 or less, the first elastic member can easily absorb changes in thickness due to expansion and contraction of the battery cell 11a. The Poisson's ratio of the first elastic member is not limited, but is, for example, 0 or more.

The porosity of the foam body 14a is not limited, but is, for example, 30% or more and 95% or less.

The thickness of the foam body 14a at 100% SOC is not limited, but is, for example, 0.07 mm or more and 0.5 mm or less.

The material constituting the foam body 14a is not limited, but examples thereof include polyurethane, silicone resin, ethylene propylene rubber, styrene resin, olefin resin, polyamide, and polyester.

The porosity of the honeycomb structure 14b is preferably 78% or more. When the porosity of the honeycomb structure 14b is 78% or more, the honeycomb structure 14b can easily absorb changes in thickness due to expansion and contraction of the battery cells 11a. The porosity of the honeycomb structure 14b is not limited, but is, for example, 48% or more and 90% or less.

The thickness of the honeycomb structure 14b at 100% SOC is not limited, but is, for example, 0.5 mm or more and 1.0 mm or less.

The material constituting the honeycomb structure 14b is not limited, but examples thereof include rubbers such as silicone rubber (VMQ), ethylene propylene diene rubber (EPDM), fluoro rubber (FKM), nitrile rubber (NBR), hydrogenated nitrile rubber (HNBR), chloroprene rubber (CR), acrylic rubber (ACM), butyl rubber (IIR), urethane rubber (U), chlorosulfonated polyethylene rubber (CSM), and epichlorohydrin rubber (ECO).

As the second elastic member, a member having a porous structure other than the honeycomb structure 14b may be used. The member having a porous structure can be manufactured, for example, using a mold, a 3D printer, or a precision water jet. In a case where the member having a porous structure has a through hole, the cross-sectional shape of the through hole may be triangular, quadrangular, etc., in addition to hexagonal.

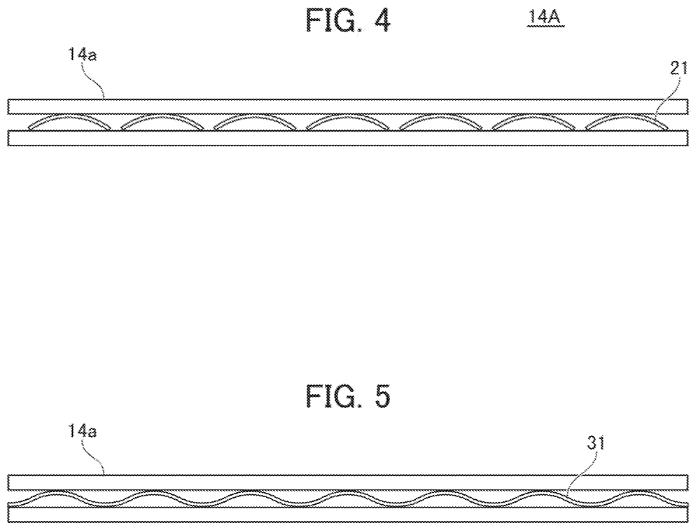

FIG. 4 shows a modification of the cushioning material 14.

A cushioning material 14A is the same as the cushioning material 14 except that a member in which a plurality of arc-shaped leaf springs 21 are arranged in parallel is disposed as the second elastic member between the pair of foam bodies 14a.

The Young's modulus of the leaf spring 21 is preferably 35 GPa or more. When the Young's modulus of the leaf spring 21 is 35 GPa or more, the leaf springs 21 can easily absorb changes in thickness due to expansion and contraction of the battery cells 11a. The Young's modulus of the leaf spring 21 is not limited, but is, for example, 200 GPa or less.

The material constituting the leaf spring 21 is not limited, but examples thereof include metals such as stainless steel and carbon steel, resins such as epoxy resins, phenol resins, and nylon resins, and fiber reinforced plastics (FRP).

As the second elastic member, a member having a leaf spring structure other than the member in which a plurality of arc-shaped leaf springs 21 are arranged in parallel may be used. For example, instead of arranging a plurality of arc-shaped leaf springs 21 in parallel, a wave-shaped leaf spring 31 (see FIG. 5) may be arranged. This facilitates manufacturing of the cushioning material.

The battery cell 11a is not limited, but examples thereof include solid-state battery cells such as all-solid-state lithium ion battery cells and all-solid-state lithium metal battery cells, and lithium metal battery cells. Among them, a solid-state battery cell is preferable.

Hereinafter, a case where the battery cell 11a is an all-solid-state lithium metal battery cell will be described.

In the all-solid-state lithium metal battery cell, for example, a positive electrode current collector, a positive electrode material mixture layer, a solid electrolyte layer, a lithium metal layer, and a negative electrode current collector are sequentially laminated.

The positive electrode current collector is not limited, but examples thereof include aluminum foil.

The positive electrode material mixture layer includes a positive electrode active material, and may further include a solid electrolyte, a conductivity aid, a binder, and the like.

The positive electrode active material is not limited as long as it can occlude and release lithium ions. Examples thereof include LiCoO₂, Li(Ni_{5/10}Co_{2/10}Mn_{3/10})O₂, Li(Ni_{6/10}Co_{2/10}Mn_{2/10})O₂, Li(Ni_{8/10}Co_{1/10}Mn_{1/10})O₂, Li(Ni_{0.8}Co_{0.15}Al_{0.05})O₂, Li(Ni_{1/6}Co_{4/6}Mn_{1/6})O₂, Li(Ni_{1/3}Co_{1/3}Mn_{1/3})O₂, LiCoO₄, LiMn₂O₄, LiNiO₂, LiFePO₄, lithium sulfide, and sulfur.

The solid electrolyte constituting the solid electrolyte layer is not limited as long as it is a material capable of conducting lithium ions, and examples thereof include an oxide electrolyte and a sulfide electrolyte.

The negative electrode current collector is not limited, but examples thereof include copper foil.

Although embodiments of the present invention have been described above, the present invention is not limited to the above-described embodiments, and the above-described embodiments may be modified as appropriate within the scope of the intent of the present invention.

### EXPLANATION OF REFERENCE NUMERALS

10 battery module
11 battery cell stack
11a battery cell
12 end plate
13 binding bar
14 cushioning material
14a foam body
14b honeycomb structure
21 leaf spring
31 wave-shaped leaf spring

What is claimed is:

1. A battery module, comprising:
a battery cell stack in which a plurality of battery cells are stacked;
a pair of plate-shaped members provided at both ends of the battery cell stack in a stacking direction; and
a cushioning material disposed between the plurality of battery cells and/or between the battery cell stack and one of the plate-shaped members,
the cushioning material comprising a pair of first elastic members arranged on both outer sides in the stacking direction of the battery cell stack, and a second elastic member disposed between the pair of first elastic members,
the second elastic member having a spring constant per unit area of 0.9 MPa/mm or more.

2. The battery module according to claim 1, wherein the second elastic member has a porous structure.

3. The battery module according to claim 2, wherein the second elastic member comprises rubber.

4. The battery module according to claim 1, wherein the second elastic member has a leaf spring structure.

5. The battery module according to claim 4, wherein the second elastic member is a wave-shaped leaf spring.

6. The battery module according to claim 4, wherein the second elastic member comprises a resin.

7. The battery module according to claim 1, wherein the battery cells are solid-state battery cells.
